(19) United States
(12) Patent Application Publication
(10) Pub. No.: US 2011/0027754 A1
(43) Pub. Date: Feb. 3, 2011

(54) DENTAL PLIERS WITH ADJUSTABLE BUMPER

(76) Inventor: Richard Golden, Detroit, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/900,003

(22) Filed: Oct. 7, 2010

Related U.S. Application Data
(63) Continuation-in-part of application No. 11/095,355, filed on Mar. 31, 2005.
Application No. 11/095,355 is a continuation-in-part of application No. 12/026,213, filed on Feb. 5, 2008.
Application No. 12/026,213 is a continuation-in-part of application No. 12/026,180, filed on Feb. 5, 2008.
(60) Provisional application No. 60/888,261, filed on Feb. 5, 2007.

(51) Int. Cl. A61C 3/14

(52) U.S. Cl. 433/159

(57) ABSTRACT

A dental pliers design removing teeth and which incorporates a first jaw portion and a second and offsetting handle portion and which permits a rotating, rather than a pulling, force to be applied to a selected tooth or root tip and in order to more quickly and efficiently extract the tooth from the patient's mouth. An adjustable pad support portion is associated with the selected jaw and can further include a threaded bolt which is adjustable relative to a collar associated with the handle in directions towards and away from the jaw. One or more cushioning and replaceable insert can also be seated over a mounting pedestal supporting end of the stem.

### CROSS-REFERENCE TO RELATED APPLICATIONS

This application is a Continuation-in-part of application Ser. No. 11/095,355 filed on Mar. 31, 2005. This application is also a Continuation-in-part of application Ser. No. 12/026,180 filed on Feb. 5, 2008 and application Ser. No. 12/026,213 filed on Feb. 5, 2008, both of which claim the benefit of U.S. Provisional Application 60/888,261 filed on Feb. 5, 2007.

### FIELD OF THE INVENTION

The present invention relates generally to dental pliers or dental forcep designs. More particularly, the present invention discloses a dental pliers design removing teeth and which incorporates a first jaw portion and a second and offsetting handle portion, the advantage of which is to permit a rotating, rather than a pulling, force to be applied to a selected tooth and in order to more quickly and efficiently extract the tooth from the patient's mouth. An adjustable pad support portion is associated with the selected jaw and can further include a threaded bolt which is adjustable relative to a collar associated with the handle in directions towards and away from the jaw. A cushioning and replaceable insert can also be seated over a mounting end of the stem.

### BACKGROUND OF THE INVENTION

The prior art is well documented with various types and examples of dental pliers (also known as dental forcep) designs. The general purpose of such forceps or pliers designs is to extract (or pull) a decayed and damaged tooth from a patient's mouth.

### SUMMARY OF THE INVENTION

The present invention discloses a dental pliers appliance, as well as an associated method, for removing teeth and which incorporates a first jaw portion and a second and offsetting handle portion. As stated previously, the advantage of the dental pliers design of the invention is to permit a rotating, rather than a pulling, force to be applied to a selected tooth and in order to more quickly and efficiently extract the tooth from the patient's mouth and in particular from a location below the gum line and bone in an outward direction.

The present invention is further an improvement over prior art dental appliances (pliers and/or forceps) in the design of the intentional offset or misalignment of the jaw and the support (or pad). This misalignment results in a greater and more efficient rotating force (and as opposed to a conventional pulling or withdrawing force) capable of being exerted directly upon the tooth and in order to quickly and efficiently remove the tooth without any damage to the patient's dental bridge.

The dental pliers appliance, according to any of the preferred embodiments, includes first and second pivotally interconnected handles. Each of the handles terminates along one end in a user-grasping portion and, at opposite extending ends, in a further selected portion suitable for engaging the patient's mouth. In particular, the first handle terminates in an arcuately extending and pointed jaw having a serrated inner facing edge, whereas the second handle terminates in an opposing and offset pad support.

In use, the pointed jaw portion of the pliers appliance is positioned to abut against an inwardly facing side of a selected tooth, a location proximate and below the patient's gum line; whereas a surface of the offset and pad shaped support aligns along the patient's gum and below the gum line. The configuration of the dental pliers appliance is further such that the offset support defines a center point of rotation proximate an edge location just below the patient's gum line. During combined outwardly and downwardly actuated rotation of the handles, the tooth is caused to pivot forwardly and forcibly dislodge from the gum line and bone and due to the configuration and positioning of the pointed jaw portion and offsetting support.

The configuration of the handles, with associated jaw and support portions, varies between a first variant suited for removing teeth projecting from and along a lower gum line and jaw bone of a patient and a second variant likewise suited for removing teeth projecting from and along an upper gum line. The second variant further includes first and second sub-variants, these being mirror images of one another, and which are particularly suited for engaging and dislodging teeth extending along respective halves of the upper gum line.

Additional features of the dental pliers appliance include the ability of the appliance to successfully engage and dislodge broken or fractured teeth (root tips), such as which in particular exhibit very little tooth mass extending at or above the gum line and despite having an embedded root tip. Also, it is contemplated that a sanitary, and typically flexible and plasticized, cap attachment is provided and which is capable of being releasably secured over the configured support and during such positioning of the support along the patient's gum line.

The invention further exhibits an adjustable pad support portion associated with the selected jaw and which can further include, without limitation, a threaded bolt which is adjustable relative to a collar associated with the handle in directions towards and away from the jaw. A cushioning and replaceable insert can also be seated over a mounting end of the stem.

### BRIEF DESCRIPTION OF THE DRAWINGS

FIG. 1 is an illustration of a conventional plier design and further illustrating the previously known manner of withdrawing teeth utilizing a pulling or withdrawing force;

FIG. 2 is a plan view of a first variant of the dental pliers according to a first variant for use in removing teeth located within a patient's lower jaw and according to the present invention;

FIG. 3 is an enlarged and sectional perspective view of the dental pliers tool according to FIG. 1 and which further illustrates the jaw and support according to the present invention;

FIG. 4 is an illustration, of a nature similar to that shown in FIG. 1, and showing the tool according to FIGS. 2 and 3 in a first engaged position relative a patient's tooth located along the bottom jaw;

FIG. 5 is an illustration of a furthering removal or cantilevered position of the tooth and in which the tool, also shown in FIG. 4, is rotated resulting in the tooth being forcibly disengaged from the patient's lower bridge and gum line;

FIG. 6 is plan view of a second variant of the dental pliers tool for use in removing teeth located along a first half of a patient's upper jaw and according to the present invention;

FIG. 7 is a side view of the dental pliers tool illustrated in FIG. 6 and according to the present invention;

FIG. 8 is a side view of an opposite and minor image dental pliers tool, with respect to that illustrated in FIGS. 6 and 7, and which is used for removing teeth located along a second half of a patient's upper jaw;

FIG. 9 is an enlarged and sectional perspective view of the dental pliers tool according to the upper jaw variant of FIG. 8 and which further illustrates the jaw and support according to the present invention;

FIG. 10 is an illustration, of a nature similar to that previously shown in FIG. 4, and showing the tool according to either of the sub-variants of FIGS. 7 and 8, in a first engaged position relative a patient's tooth located along a selected half of the upper jaw;

FIG. 11 is an illustration of a furthering removal or cantilevered position of the tooth and in which the tool, also shown in FIG. 10, is rotated resulting in the tooth being forcibly disengaged from the patient's upper bridge and gum line;

FIG. 12 is an illustration of a further dental pliers tool exhibiting a threadably adjustable bumper, also termed pad support portion, arrayed opposite the arcuate and pointed jaw;

FIG. 13 is a rotated illustration of the tool shown in FIG. 12; and

FIG. 14 is a partially exploded view of the dental pliers tool and showing the removable nature of the bridge cushioning pad support.

### DETAILED DESCRIPTION OF THE PREFERRED EMBODIMENTS

Referring now to FIG. 2, a pair of dental pliers is illustrated at 10 according to a first preferred variant of the present invention and for use in removing teeth located along a lower jaw line of a patient. As discussed previously the dental pliers, according to any of the design variants disclosed herein, is an improvement over prior art dental pliers and forceps in that it facilitates providing an outward directed and rotating force, rather than a pulling force, applied to a selected tooth and in order to more quickly and efficiently extract the tooth from the patient's gum line and bone. The present invention is again an improvement over prior art dental appliances (pliers and/or forceps) in that the intentional offset or misalignment of the jaw and the pad (or support) allows a greater and more efficient rotating force (and as opposed to a conventional pulling or withdrawing force) to be exerted directly upon the tooth, at a location below the patient's gum line, and in order to quickly and efficiently remove the tooth without any damage to the patient's dental bridge.

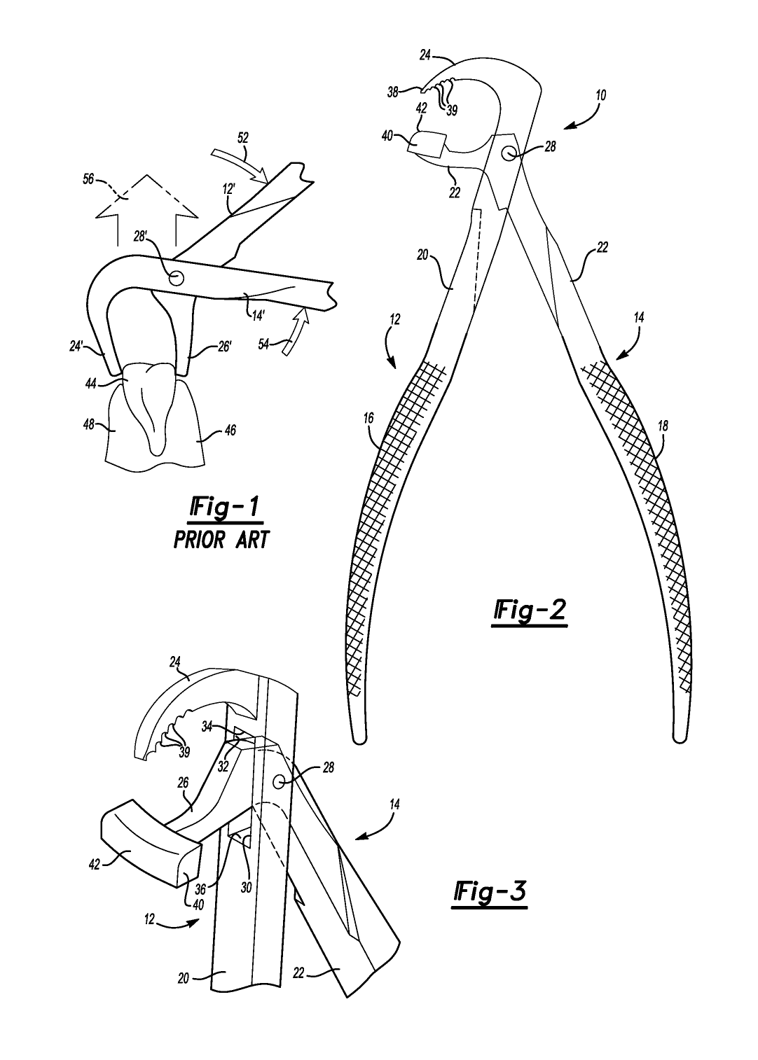

Referring again to FIG. 2 as well as to FIG. 3, the dental pliers variant 10 includes a first handle and a second handle, which are generally referenced at 12 and 14, respectively. Each of the handles 12 and 14 include extending and configured user grasping portions, see at 16 and 18, respectively, as well as associated intermediate portions 20 and 22 and terminating portions 24 and 26. In the particular instance of the variant of FIGS. 1 and 2, the configuration of the dental pliers appliance 10 illustrated is specifically suited for the dislodging and removal of teeth located along a lower gum line and jaw bone of a patient.

The handles 12 and 14 are further hingedly interconnected at pivot point 28. In a preferred variant, an aperture is defined along and within the first handle 12, and such as is best illustrated in FIG. 3 by inwardly facing side walls 30 and 32 and interconnecting end walls 34 and 36 which define an elongated and rectangular slot shaped aperture. The aperture in first handle 12 is located in proximity to its terminating end 24 and such that the second handle 14, a point intersecting the first handle 12, extends through the aperture. A pin (again defined by pivot point 28) extends crosswise through the intersecting location of the first and second handles 12 and 14 to define the pivotal connection. It is further understood that both the configuration of gripping portions of the handles, as well as the manner in which the handles are pivotally connected together, may be modified without departing from the scope of the invention.

Referring again to FIGS. 2 and 3, the terminating portion 24 (associated with first handle 12) exhibits an arcuately/downwardly extending and substantially pointed jaw 38. The jaw 38 further includes a plurality of serrated surfaces 39 along its inner edge.

In contrast, the second terminating portion 26 (associated with second handle 14) exhibits a three-dimensional and offset pad-shaped support 40 exhibiting an ergonomically configured and supporting surface 42 which is designed to substantially match that of the patient's gum line.

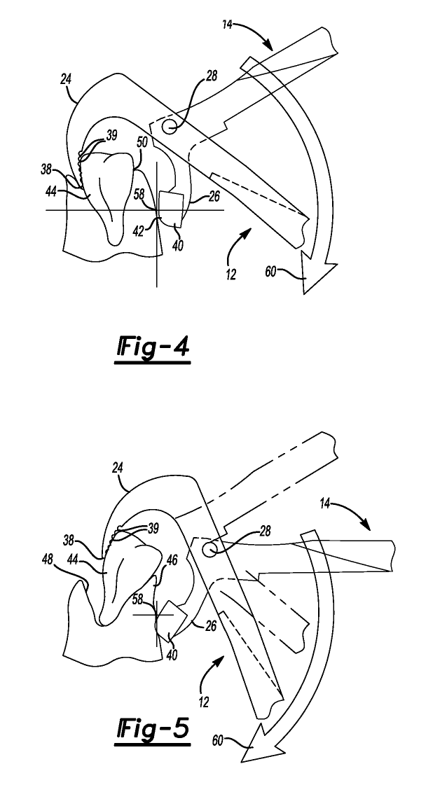

Prior to providing a description of the engaging and removal positions of the appliance 10, relative to a patient's tooth and as is shown in FIGS. 4 and 5, a description of the prior art and existing technique for removing a tooth will now be explained and with further reference to FIG. 1. In particular, conventionally designed handles 12′ and 14′ are shown in the Prior Art view of FIG. 3, are pivotally connected at 28′, and terminate in associated and opposing ends 24′ and 26′ in the form of jaw portions.

As further shown in FIG. 1, the prior art technique for removing a selected tooth 44 from its associated gum 46 and bone 48 contemplates the opposing jaw portions, see again 24′ and 26′, engaging opposite facing sides of the tooth 44, above a gum line 50 from which the tooth 44 projects. Upon positioning of the prior art pliers device in the position illustrated in FIG. 3, and further upon the handles 12′ and 14′ being compressed in the directions illustrated at 52 and 54, respectively, a further pulling force (referenced by directional arrow 52) is concurrently applied in a direction opposite that of the holding force established between the tooth 44 and the patient's gum 46 and bone 48. While eventually effective in removing the patient's tooth 44, it has been found that the prior art application of FIG. 3 results in both the requirement of extensive time and effort necessary to successfully dislodge the tooth, this having a commensurate effect on the patient's comfort level as well as increasing the likelihood of the tooth becoming fractured or broken during the removal process.

Referring again to FIGS. 4 and 5, first engagement and second actuating positions are again illustrated in reference to the dental appliance tool and method of operation according to the present invention. In particular, and referencing first FIG. 4, the pad support 40, with ergonomic surface 42, is illustrated in position along a selected location of the patient's gum 46 and below the gum line 50.

Upon further aligning of the opposing and pointed jaw 38 in abutting fashion against an inwardly facing side of the tooth, again shown at 44 and such that the pointed edge projects a distance between and below the adjoining gum line and tooth and with the serrated edge 39 located against the inwardly facing edge of the tooth 44, the offset support 40 defines a center point of rotation 58 proximate an edge location of the gum line 46 and bone 48. The handles 12 and 14 are then initiated in a rotating direction in an outward fashion away from the patient's gum line 46, and as illustrated by directional arrow 60.

Referring further to FIG. 5, continued rotation of the handles 12 and 14 along the direction of arrow 62 causes a cantilever or dislodging force to be applied to the tooth 44, about the center point of rotation 58, and so that the tooth 44 is caused to be forcibly dislodged, along the gum line 50, and from the patient's gum 46 and associated bone 48. Of significant advantage is the ability to apply a single and multiplied rotating and cantilevering force to the dental pliers appliance, and which is measured by the offsetting distance between the edge of the jaw 38 and the center point of rotation 58 established by the support 40. The ability to apply such a combined and unidirectional rotating force causes the tooth 44 to be much more quickly dislodged and removed than in the instances of the prior art in which grasping forces 52 and 54 tend to cancel out a significant degree of the pulling/withdrawing force 56 (see again FIG. 1) and by which no effective cantilevering or rotating forces are created to assist in tooth removal.

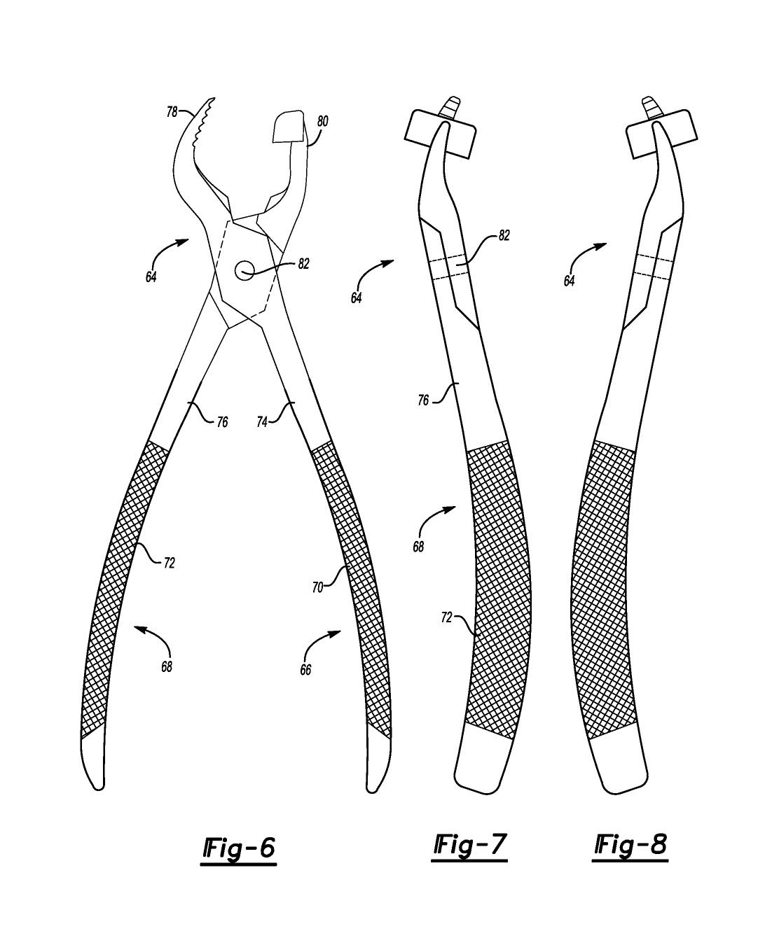

Referring now to FIGS. 6 and 7, plan and side views are illustrated, respectively, of a second variant 64 of a dental pliers appliance for use in removing teeth according to the present invention. In particular the variant 64 of FIGS. 6 and 7, and as will be further explained in reference to FIGS. 10 and 11, is suited for removing teeth located along a patient's upper jaw and gum line.

The features of the dental pliers appliance 64 are essentially the same as those associated with the variant 10 illustrated in FIGS. 2 and 3 and again include handles 66 and 68 with grasping portions 70 and 72, intermediate extending portions 74 and 76, and configured and opposing terminating portions 78 and 80. The appliance 64 further includes a pivotal connection 82 constructed by reduced section and overlapping portions (see in particular FIG. 7), of each of the intermediate extending portions 74 and 76, and through which is inserted a pin (not shown).

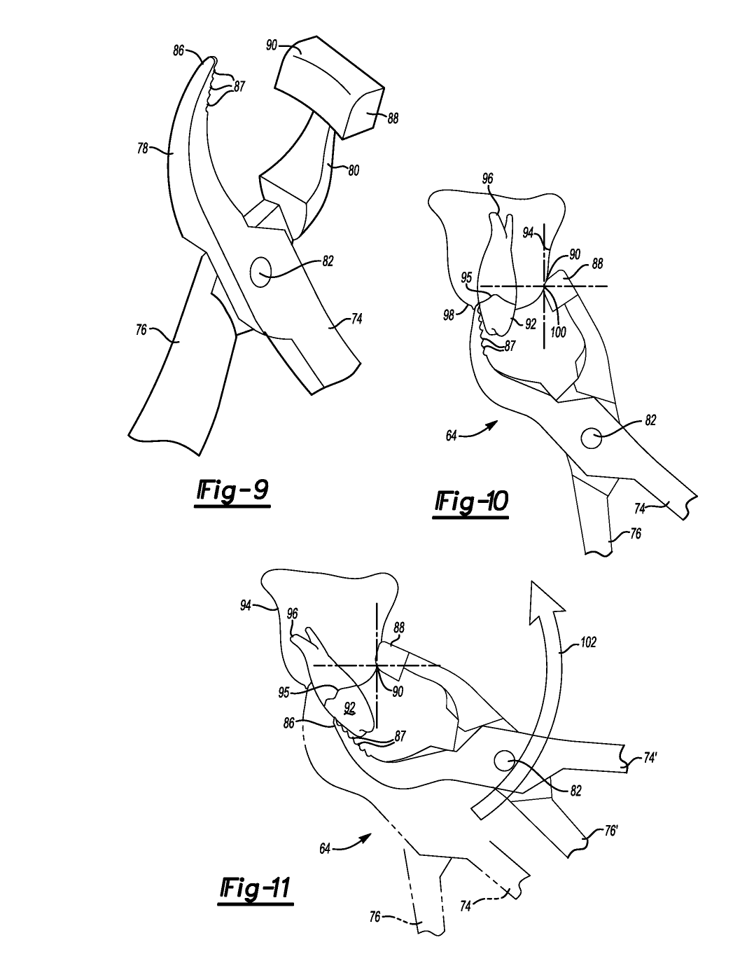

As also shown in FIG. 9, the terminating portion 78 is again provided with a pointed and angled jaw 86 (with inner and serrated surfaces 87) and the terminating portion 80 as a pad-shaped support 88 with ergonomically configured surface 90. Referring further to FIGS. 10 and 11, engagement and removal positions are illustrated of the appliance 64 in relation to a tooth 92 located within an upper gum 94 and bone 96 of a patient. Also illustrated in FIGS. 10 and 11 at line 95 is a breakaway location and by which a fractured root tip (such as resulting from an unsuccessful tooth removal procedure) remains embedded in the patient's gum line and bone. As will be described, the pliers device of the present invention is effective in removing root tips as well as complete (undamaged) teeth.

As illustrated in the initial engagement position of FIG. 10, the support 88 with ergonomic surface 90 is positioned against the gum 94, at a position above in this instance the patient's upper jaw gum line 98. At the same time, the angled jaw 86 is again abutted against an inwardly facing side of the tooth 92 (again a recessed distance above the gum line 98 and such that the inwardly serrated surface 87 grips the corresponding inner surface of the teeth) and in order to define a center point of rotation 100 of the support 88, which is offset the desired distance from the jaw 86 and the upper gum line 98.

Referring to FIG. 11, a rotating and cantilevering force is applied along the handles of the appliance 64, in the direction of arrow 102 (from initial positions designated by handles 74 and 76 to angularly displaced positions 74′ and 76′), and so that the selected upper tooth 92 is likewise rotated and forcibly dislodged from the gum 94 and bone 96 defining the patient's upper bridge. The same forces of physics apply in the upper jaw variant 64 of the appliance, as compared to those illustrated and described in reference to the lower jaw appliance 10 in FIGS. 4 and 5, and by which the rotating and cantilevering forces about the center point of rotation effectively and efficiently actuate, dislodge and remove the tooth in the desired pivoting fashion about the gum line with a minimum of time and effort.

Referring to FIG. 8, a side view of an opposite and mirror image dental pliers tool, see at 64′, is illustrated and with respect to that illustrated at 64 in FIGS. 6 and 7. In particular, the tool 64′ is an identically constructed, albeit again mirrored image configuration, of the variant 64 and for the specific purpose of removing teeth located along a selected and second half of a patient's upper jaw. In comparison, the variant 64 is suited for removing teeth from a first upper extending half of the patient's jaw and the particular ergonomic configuration of either of the appliance variants 64 or 64′, when viewed in side profile, is depending upon that which is easiest to grasp and manipulate during the engaging and dislodging procedure. The mirrored image sub-variant 64′ is otherwise identically constructed as that illustrated at 64 such that a repetitive description of its elements is not required.

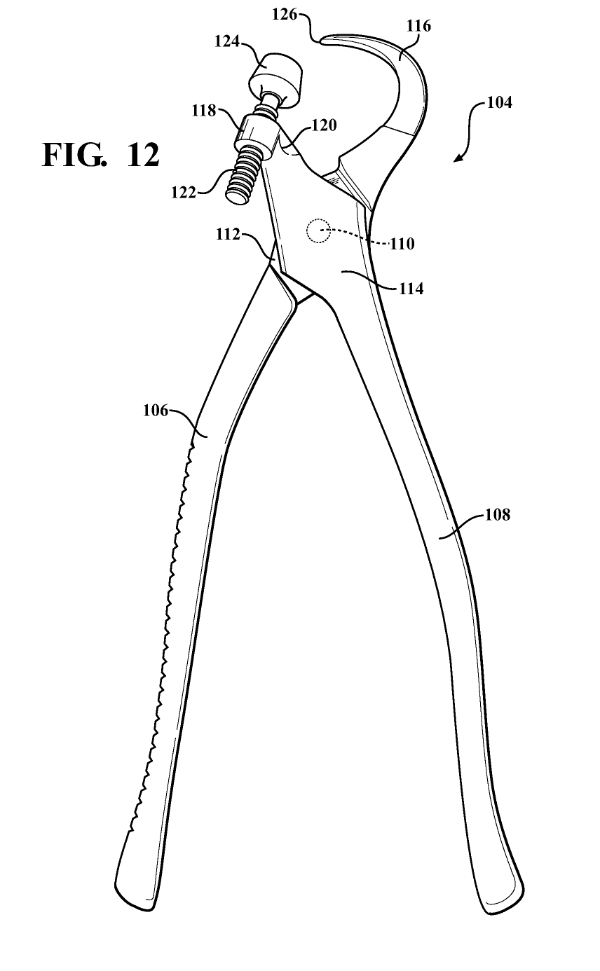

Referring now to FIG. 12, an illustration is generally shown at 104 of a further variant of dental pliers tool. The variant 104 is generally operable in the same manner as the tool previously depicted at 10 in FIG. 12 and includes a first handle 106 (optionally serrated or fenestrated) in combination with a second pivotally engageable (and likewise optionally serrated) handle 108. The pivot point is generally hidden from view but is illustrated by phantom pin 110 configured between overlapping flattened neck locations 112 and 114 respectively associated with the handles 106 and 108.

Additional features again include an angled beak or jaw, see at 116, extending from associated overlapping location 112 of jaw 106. In contrast to the fixed pad support previously described, an adjustable support includes a collar 118 fixed or mounted to an upper pedestal mounting location 120 of the overlapping neck location 114. A uniquely configured and threaded bolt or pin is depicted at 122 and exhibits exterior threads which are rotationally inter engaged with hidden internal threads associated with the collar 118.

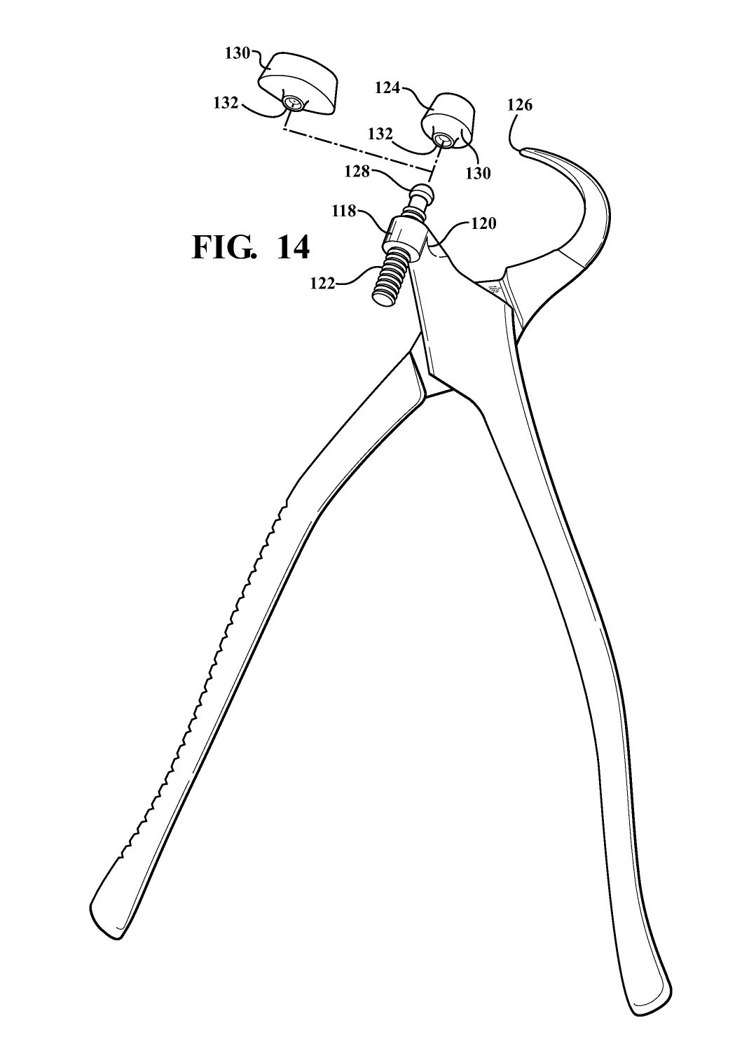

In this fashion, the rotation of the stem 122, such as which can be easily by accomplished with one-handed action such via the dental professionals thumb, results in an end supported pad 124 being displaced in directions both toward and away from the generally pointed end 126 of the beak or jaw 116. As is further shown in FIG. 14, a partially exploded view of the dental pliers tool exhibits the removable nature of the bridge cushioning pad support and which can include a soft silicone or other suitable medical grade sanitary covering.

As further shown, the cushioning portion is depicted as exhibiting a rounded configuration, it further being understood that any symmetrical or asymmetrical shape, such as further including the widened pad supports previously described, can be easily substituted. Also depicted in FIG. 14 is an end most seating portion 128 associated with the rotatable bolt 122 and which is configured, such as with a pseudo spherical shape, to resistively seat and engage an opposingly apertured underside location, further at 130, designed into the attachable pad 124.

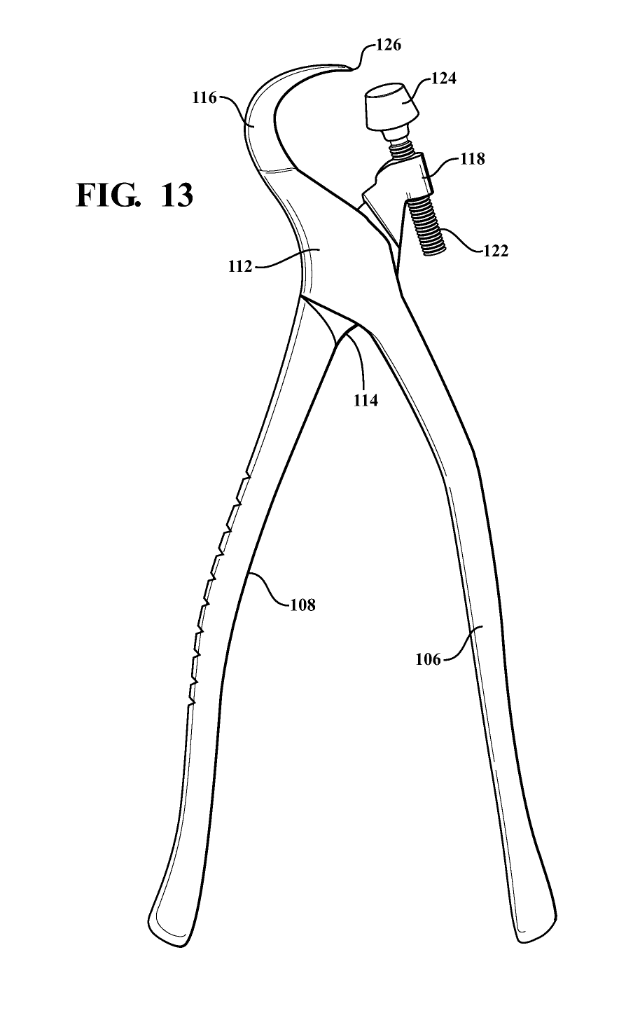

It is understood that the variant of pliers tool 104 depicted in FIGS. 12-14 can include but one of a wide variety of potential designs in which the bumper or pad support is positionally readjustable in order to achieve a quickly adjusted location relative to the jaw 116. This can further contemplate a variety of tools shaped or otherwise configured for engaging specified upper and lower half or quadrant locations associated with the patient's mouth. Without limitation, this can include the provision of other mounting structure associated with the pad supporting jaw 108 not limited to that depicted. It is also envisioned and understood that any reconfiguration of adjustable pad support may not, of necessity, require a thumb induced rotation associated with a threaded bolt or screw, but can incorporate and type of catch and release type mechanism for permitting lineal and non-rotatable advancement of the pad support.

Additional variants contemplate the attachable pad 124 being provided as a plurality of interchangeable or kit supplied pad supports. These can further include alternately shaped supports, such as further depicted by widened pad support 130 in FIG. 14 with seating aperture 132 and which can be employed in alternate substituted manner at varying bridge supporting locations during the rotational removal of specified teeth and root tips. The design and dimensioning of the pedestal support 128 of the threaded adjustment bolt 122, relative the individual pads 124 is further such that the pads 124, 130, et seq. can be easily and quickly mounted/dismounted from the pedestal support, such as in a resistive fitting fashion.

Having described my invention, additional preferred embodiments will become apparent to those skilled in the art to which it pertains and without deviating from the scope of the appended claims.

I claim:

1. A dental pliers appliance for removing teeth from a patient's gum line and bone, said appliance comprising:
a first handle and a pivotally connected second handle, each of said first and second handles including a user grasping portion;
said first handle terminating in a generally pointed jaw, said second handle terminating in a pad support opposing said jaw and displaceable relative to said jaw;
said support contacting an outer surface associated with a patient's mouth at or below the gum line, said jaw applying in abutting fashion to contact against an inwardly facing side of a tooth, a pointed edge associated with said jaw penetrating a predetermined embedded distance below the gum line and against the tooth, said handles being rotated in an outward fashion away from the patient's gum line, applying a rotating force to the tooth, and to forcibly dislodge the tooth from the patient's gum line and bone.

2. The invention as described in claim 1, said second handle further comprising a collar support which threadably receives an inter-rotatable and displaceable bolt.

3. The invention as described in claim 2, said pad support further comprising at least one biasing component resistively seated upon an end of said bolt.

4. The invention as described in claim 1, said support surface further comprising an ergonomic configuration substantially matching that of the patient's gum.

5. The invention as described in claim 1, further comprising an aperture defined along and within said first handle in proximity to said arcuately extending jaw, said second handle intersecting said first handle at a point in which it extends through said aperture, a pin extending crosswise through said first and second handles at said intersection to define said pivotal connection.

6. The invention as described in claim 1, further comprising said first and second handles exhibiting an angled side profile such that said appliance is configured for engaging and dislodging a selected tooth located along either of a lower or an upper gum line and jaw bone of a patient.

7. The invention as described in claim 1, said appliance having a specified shape and size and being configured for engaging and dislodging a fragmented tooth and associated root tip.
